(19) United States
(12) Patent Application Publication
(10) Pub. No.: US 2017/0355876 A1
(43) Pub. Date: Dec. 14, 2017

(54) COATING MATERIAL COMPOSITIONS AND COATINGS PRODUCED THEREFROM AND ALSO USE THEREOF

(71) Applicant: BASF COATINGS GmbH, Muenster (DE)

(72) Inventors: Guenter KLEIN, Muenster (DE); Andreas FEIGL, Drensteinfurt (DE); Christian ARENS, Muenster (DE); Wilfried STUEBBE, Greven (DE); Ulrike WENKING, Steinfurt-Borghorst (DE); Marlen LAERBUSCH, Duelmen (DE); Mareike MATHIEU, Haltern (DE)

(73) Assignee: BASF COATINGS GmbH, Muenster (DE)

(21) Appl. No.: 15/526,852

(22) PCT Filed: Nov. 30, 2015
(86) PCT No.: PCT/EP2015/078035

§ 371 Date: May 15, 2017

(30) Foreign Application Priority Data
Dec. 8, 2014 (EP) 14196791.9

(51) Int. Cl. C09D 175/16; C08G 18/80; C08G 18/62

(52) U.S. Cl. CPC C09D 175/16; C08G 18/6229; C08G 18/809; C08G 18/8087

(57) ABSTRACT

The present invention relates to nonaqueous coating material compositions comprising
(A) at least one polyhydroxyl group-containing component (A),
(B1) at least one isocyanate and silane group-containing component (B1), and
(D) at least one catalyst (D) for the crosslinking of silane groups,
   which composition comprises
(B2) at least one isocyanate group-containing component (B2) which is different from component (B1) and which additionally has at least one perfluoroalkyl group of the formula (I)

CR¹₃—(CR²₂)_{f}— (I)
where
R¹ and R² independently of one another are H, F and/or CF₃, but R¹ and R² may not both be H, and
f is 1 to 20, preferably 3 to 11, more preferably 5 to 7.

A further subject of the present invention are the coatings produced from these coating material compositions, and also their use.

The present invention relates to nonaqueous coating material compositions comprising at least one polyhydroxyl group-containing component (A) and at least one isocyanate and silane group-containing component (B1). A further subject of the present invention are the coatings produced from these coating material compositions, and also their use, particularly for automotive OEM finishing, automotive refinish, and the coating not only of parts for installation in or on vehicles, but also of plastics.

WO 2013/081892 discloses coating materials which comprise a polyhydroxyl group-containing binder component and a crosslinker having isocyanate groups and having fluoroether groups, the fluoroether content of the coating materials being between 0.1 and 3.0 wt %, based on the resin solids content of the coating material. The crosslinkers in that case are produced by reaction of polyisocyanates with fluorine-containing polyether polyols which have at least one —OCH₂CₙF₂ₙ₊₁ group, where n is 1 or 2. These coating materials are used as clearcoat material for producing multicoat paint systems, in the automobile finishing segment, for example, and lead to coatings which are easy to clean and have a reduced soiling tendency. Moreover, the resulting coatings exhibit good optical properties, good appearance, and high gloss.

Furthermore, EP-B-1 664 222 discloses fluorinated topcoat materials which comprise as binders 10 to 90 wt %, preferably 40 to 80 wt %, of fluorinated silane polymers and preferably a polyhydroxyl group-containing binder component and also a polyisocyanate crosslinking agent. The fluorinated silane polymers are obtained in particular by polymerization of ethylenically unsaturated monomers having silane groups, ethylenically unsaturated monomers having fluorine functionality, and further comonomers. According to that specification, the adhesion of the resulting coating to subsequent coatings, which is frequently impaired through the use of such fluorinated silane polymers, is improved by the addition of specific fluorinated urethane additives. These fluorinated urethane additives are prepared by first reacting 0.45 to 1.0 equivalent of the isocyanate groups of diisocyanates and polyisocyanates with a fluorinated monoalcohol, and subsequently reacting any residual isocyanate groups still present with a polyoxyethylene/polyoxypropylene glycol or with an amino-functional silane.

Furthermore, WO 09/086029 discloses coating materials, especially surfacers and clearcoat materials, which comprise a binder (A) having functional groups containing active hydrogen, in particular a hydroxy-functional polyacrylate resin, a crosslinker (B) having free isocyanate groups, and (C) at least one epoxy-functional silane. The use of the epoxy-functional silane in the surfacer and in the clearcoat produces multicoat paint systems having very good wet adhesion and also very good stability during high-pressure cleaning and in the humidity/heat test.

These coating materials known from the prior art, however, are unable to combine the particular qualities of the fluorine building blocks used with an outstanding scratch resistance, of the kind required particularly for a premium automotive clearcoat.

Furthermore, the as yet unpublished European patent application EP 2013197704.3 and the as yet unpublished European patent application EP 2013197695.3 describe reaction products of isocyanatofunctional silanes with alpha,omega-hydroxy-functionalized oligoesters and their use as adhesion promoters in coating materials, more particularly solventborne surfacers and solventborne clearcoats.

Lastly, WO 08/74491, WO 08/74490, WO 08/74489, WO 09/077181, and WO 10/149236 disclose coating materials wherein the isocyanate and silane group-containing compound (B) used is based on known isocyanates, preferably on the biuret dimers and isocyanurate trimers of diisocyanates, more particularly of hexamethylene diisocyanate. Relative to conventional polyurethane coating materials, these coating material compositions have the advantage of significantly improved scratch resistance in conjunction with good weathering stability. In need of improvement with these coating materials is the soiling tendency of the resulting coatings. There is also a desire for the provision of clearcoat surfaces which are very easy to clean and which are often also referred to as an “easy-to-clean surface”.

### Problem

A problem addressed by the present invention was therefore that of providing coating material compositions, particularly for automotive OEM finishing and automotive refinish, that lead to coatings which are highly scratch-resistant and in particular exhibit a high level of gloss retention after scratch exposure. At the same time, however, the resulting coatings ought to have a low soiling tendency and ought to ensure easy cleaning of the surfaces (“easy-to-clean surface”).

Moreover, the resultant coatings ought to exhibit good chemical resistance and acid resistance and also good weathering stability.

Moreover, the coatings and paint systems, especially the clearcoat systems, ought to be able to be produced even at coat thicknesses >40 μm without stress cracks occurring. The coating materials, furthermore, ought to meet the requirements typically imposed on the clearcoat films in automotive OEM finishes and automotive refinishes.

Lastly, the new coating materials ought to be able to be produced easily and very reproducibly, and ought not to give rise to any environmental problems during coatings application.

### Solution

In the light of the statement of problem above, nonaqueous coating material compositions have been found, comprising
(A) at least one polyhydroxyl group-containing component (A),
(B1) at least one isocyanate and silane group-containing component (B1), and
(D) at least one catalyst (D) for the crosslinking of silane groups,
   which composition comprises
(B2) at least one isocyanate group-containing component (B2) which is different from component (B1) and which additionally has at least one perfluoroalkyl group of the formula (I)

CR¹₃—(CR²₂)_{f}— (I)
where
R¹ and R² independently of one another are H, F and/or CF₃, but R¹ and R² may not both be H, and
f is 1 to 20, preferably 3 to 11, more preferably 5 to 7.

A further subject of the present invention are multistage coating methods using these coating material compositions, and also the use of the coating material compositions as clearcoat or application of the coating method for automotive OEM finishing, automotive refinish, and/or the coating of parts for installation in or on automobiles, of plastics substrates and/or of utility vehicles.

It is surprising and was not foreseeable that the coating material compositions lead to coatings which are highly scratch-resistant and in particular exhibit a high gloss retention after scratch exposure, while at the same time having a low soiling tendency and ensuring easy-to-clean surface qualities.

Furthermore, the resultant coatings exhibit good chemical resistance and acid resistance and also a good weathering stability.

Moreover, the coating material compositions result in a highly weathering-stable network and simultaneously ensure high acid strength on the part of the coatings. Moreover, the coatings and paint systems, especially the clearcoat systems, can be produced even at film thicknesses >40 μm without stress cracks occurring. In addition to all this, the coating materials meet the requirements typically imposed on the clearcoat film in automotive OEM finishes and automotive refinishes.

Lastly, the new coating materials can be produced easily and with very good reproducibility, and do not give rise to any environmental problems during coatings application.

### DESCRIPTION OF THE INVENTION

### The Inventive Coating Material Compositions

In particular, the coating material compositions of the invention are thermally curable coating materials, in other words, preferably, coating materials which are substantially free from radiation-curable unsaturated compounds, more particularly entirely free from radiation-curable unsaturated compounds.

For the purposes of the present invention, unless otherwise indicated, constant conditions were selected in each case for the determination of nonvolatile fractions (NVF, solids). To determine the nonvolatile fraction, an amount of 1 g of the respective sample is applied to a solid lid and heated at 130° C. for 1 h, then cooled to room temperature and weighed again (in accordance with ISO 3251). Determinations were made of the nonvolatile fraction of, for example, corresponding polymer solutions and/or resins present in the coating composition of the invention, in order thereby to be able to adjust, for example, the weight fraction of the respective constituent in a mixture of two or more constituents, or of the overall coating composition, and allow it to be determined.

The binder fraction (also called nonvolatile fraction or solids content) of the individual components (A) or (B1) or (B2) or (B3) or (C) or (E) of the coating material is therefore determined by weighing out a small sample of the respective component (A) or (B1) or (B2) or (B3) or (C) or (E) and subsequently determining the solids by drying it at 130° C. for 60 minutes, cooling it, and then weighing it again. The binder fraction of the component in wt % is then given, accordingly, by 100 multiplied by the ratio of the weight of the residue of the respective sample after drying at 130° C., divided by the weight of the respective sample prior to drying.

In the case of standard commercial components, the binder fraction of said component may also be equated with sufficient accuracy with the stated solids content, unless otherwise indicated.

The binder fraction of the coating material composition is determined arithmetically from the sum of the binder fractions of the individual binder components and crosslinker components (A), (B1), (B2), (B3), (C), and (E) of the coating material.

For the purposes of the invention, the hydroxyl number or OH number indicates the amount of potassium hydroxide, in milligrams, which is equivalent to the molar amount of acetic acid bound during the acetylation of one gram of the constituent in question. For the purposes of the present invention, unless otherwise indicated, the hydroxyl number is determined experimentally by titration in accordance with DIN 53240-2 (Determination of hydroxyl value—Part 2: Method with catalyst).

For the purposes of the invention, the acid number indicates the amount of potassium hydroxide, in milligrams, which is needed to neutralize 1 g of the respective constituent. For the purposes of the present invention, unless otherwise indicated, the acid number is determined experimentally by titration in accordance with DIN EN ISO 2114.

The mass-average (Mw) and number-average (Mn) molecular weight is determined for the purposes of the present invention by means of gel permeation chromatography at 35° C., using a high-performance liquid chromatography pump and a refractive index detector. The eluent used was tetrahydrofuran containing 0.1 vol % acetic acid, with an elution rate of 1 ml/min. The calibration is carried out by means of polystyrene standards.

For the purposes of the invention, the glass transition temperature Tg is determined experimentally on the basis of DIN 51005 “Thermal Analysis (TA)—Terms” and DIN 53765 “Thermal Analysis—Differential Scanning Calorimetry (DSC)”. This involves weighing out a 10 mg sample into a sample boat and introducing it into a DSC instrument. The instrument is cooled to the start temperature, after which a 1^{st} and 2^{nd} measurement run is carried out under inert gas flushing (N₂) at 50 ml/min with a heating rate of 10 K/min, with cooling to the start temperature again between the measurement runs. Measurement takes place typically in the temperature range from about 50° C. lower than the expected glass transition temperature to about 50° C. higher than the glass transition temperature. The glass transition temperature recorded for the purposes of the present invention, in line with DIN 53765, section 8.1, is the temperature in the 2^{nd} measurement run at which half of the change in the specific heat capacity (0.5 delta cp) is reached. This temperature is determined from the DSC plot (plot of the thermal flow against the temperature), and is the temperature at the point of intersection of the midline between the extrapolated baselines, before and after the glass transition, with the measurement plot.

### The Polyhydroxyl Group-Containing Component (A)

As polyhydroxyl group-containing component (A) it is possible to use all compounds known to the skilled person which have at least 2 hydroxyl groups per molecule and are oligomeric and/or polymeric. As component (A) it is also possible to use mixtures of different oligomeric and/or polymeric polyols.

The preferred oligomeric and/or polymeric polyols (A) have number-average molecular weights Mn>=300 g/mol, preferably Mn=400-30 000 g/mol, more preferably Mn=500-15 000 g/mol, and mass-average molecular weights Mw>500 g/mol, preferably between 800 and 100 000 g/mol, more particularly between 900 and 50 000 g/mol, measured by means of gel permeation chromatography (GPC) against a polystyrene standard. Preferred as component (A) are polyester polyols, polyacrylate polyols and/or polymethacrylate polyols, and also copolymers thereof—referred to hereinafter as polyacrylate polyols; polyurethane polyols, polysiloxane polyols, and mixtures of these polyols.

The polyols (A) preferably have an OH number of 30 to 400 mg KOH/g, more particularly between 70 and 250 mg KOH/g. In the case of the poly(meth)acrylate copolymers, the OH number may also be determined with sufficient precision by calculation on the basis of the OH-functional monomers employed.

The polyols (A) preferably have an acid number of between 0 and 30 mg KOH/g.

The glass transition temperatures, measured by means of DSC measurements in accordance with DIN-EN-ISO 11357-2, of the polyols are preferably between −150 and 100° C., more preferably between −120° C. and 80° C.

Polyurethane polyols are prepared preferably by reaction of oligomeric polyols, more particularly of polyester polyol prepolymers, with suitable di- or polyisocyanates, and are described in EP-A-1 273 640, for example. Use is made more particularly of reaction products of polyester polyols with aliphatic and/or cycloaliphatic di- and/or polyisocyanates. The polyurethane polyols used with preference in accordance with the invention have a number-average molecular weight Mn>=300 g/mol, preferably Mn=700-2000 g/mol, more preferably Mn=700-1300 g/mol, and also preferably a mass-average molecular weight Mw>500 g/mol, preferably between 1500 and 3000 g/mol, more particularly between 1500 and 2700 g/mol, in each case measured by means of gel permeation chromatography (GPC) against a polystyrene standard.

Suitable polysiloxane polyols are described in WO-A-01/09260, for example, and the polysiloxane polyols recited therein can be employed preferably in combination with further polyols, more particularly those having higher glass transition temperatures.

As polyhydroxyl group-containing component (A), use is made with particular preference of polyester polyols, polyacrylate polyols, polymethacrylate polyols, and polyurethane polyols, or mixtures thereof, and very preferably of mixtures of poly(meth)acrylate polyols.

The polyester polyols (A) used with preference in accordance with the invention have a number-average molecular weight Mn>=300 g/mol, preferably Mn=400-10 000 g/mol, more preferably Mn=500-5000 g/mol, and also preferably a mass-average molecular weight Mw>500 g/mol, preferably between 800 and 50 000 g/mol, more particularly between 900 and 10 000 g/mol, in each case measured by means of gel permeation chromatography (GPC) against a polystyrene standard.

The polyester polyols (A) used with preference in accordance with the invention preferably have an OH number of 30 to 400 mg KOH/g, more particularly between 100 and 250 mg KOH/g.

The polyester polyols (A) used with preference in accordance with the invention preferably have an acid number of between 0 and 30 mg KOH/g.

Suitable polyester polyols are also described in EP-A-0 994 117 and EP-A-1 273 640, for example.

The poly(meth)acrylate polyols (A) used with preference in accordance with the invention are generally copolymers and preferably have a number-average molecular weight Mn>=300 g/mol, preferably Mn=500-15 000 g/mol, more preferably Mn=900-10 000 g/mol, and also, preferably, mass-average molecular weights Mw between 500 and 20 000 g/mol, more particularly between 1000 and 15 000 g/mol, measured in each case by means of gel permeation chromatography (GPC) against a polystyrene standard.

The glass transition temperature of the copolymers is generally between −100 and 100° C., more particularly between −40 and <60° C. (measured by means of DSC measurements in accordance with DIN-EN-ISO 11357-2).

The poly(meth)acrylate polyols (A) preferably have an OH number of 60 to 300 mg KOH/g, more particularly between 70 and 250 mg KOH/g, and an acid number of between 0 and 30 mg KOH/g.

The hydroxyl number (OH number) and the acid number are determined as described above (DIN 53240-2 and DIN EN ISO 2114, respectively).

Hydroxyl group-containing monomer building blocks used are preferably hydroxyalkyl acrylates and/or hydroxyalkyl methacrylates, such as, more particularly, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, and also, in particular, 4-hydroxybutyl acrylate and/or 4-hydroxybutyl methacrylate.

Further monomer building blocks used for the poly(meth)acrylate polyols are preferably alkyl acrylates and/or alkyl methacrylates, such as, preferably, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclopentyl acrylate, cyclopentyl methacrylate, isobornyl acrylate, isobornyl methacrylate, or, in particular, cyclohexyl acrylate and/or cyclohexyl methacrylate.

As further monomer building blocks for the poly(meth)acrylate polyols it is possible to use vinylaromatic hydrocarbons, such as vinyltoluene, alpha-methylstyrene, or, in particular, styrene, amides or nitriles of acrylic or methacrylic acid, vinyl esters or vinyl ethers, and also, in minor amounts, in particular, acrylic acid and/or methacrylic acid.

### The Hydroxyl Group-Containing Component (C)

Apart from the polyhydroxyl group-containing component (A), the coating material compositions of the invention may optionally further comprise one or more monomeric, hydroxyl group-containing components (C) that are different from component (A). These components (C) preferably account for a fraction of 0 to 10 wt %, more preferably of 0 to 5 wt %, based in each case on the binder fraction of the coating material composition (in other words based in each case on the total of the binder fraction of the component (A) plus the binder fraction of the component (B1) plus the binder fraction of the component (B2) plus the binder fraction of the component (B3) plus the binder fraction of the component (C) plus the binder fraction of the component (E)).

Low molecular mass polyols are employed as hydroxyl group-containing component (C). Low molecular mass polyols used are, for example, diols, such as preferably ethylene glycol, di- and tri-ethylene glycol, neopentyl glycol, 1,2-propanediol, 2,2-dimethyl-1,3-propanediol, 1,4-butanediol, 1,3-butanediol, 1,5-pentanediol, 2,2,4-trimethyl-1,3-pentanediol, 1,6-hexanediol, 1,4-cyclohexanedimethanol, and 1,2-cyclohexanedimethanol, and also polyols, such as preferably trimethylolethane, trimethylolpropane, trimethylolhexane, 1,2,4-butanetriol, pentaerythritol, and dipentaerythritol. Such low molecular mass polyols (C) are preferably admixed in minor fractions to the polyol component (A).

### The Combination of Component (B1) and Component (B2)

### The Isocyanate and Silane Group-Containing Component (B1)

It is essential to the invention that the coating materials comprise at least one isocyanate and silane group-containing component (B1) which is different from component (B2) and which has a parent structure derived from one or more polyisocyanates.

The polyisocyanates serving as parent structures for the isocyanate group-containing component (B1) used in accordance with the invention are preferably conventional substituted or unsubstituted polyisocyanates, such as, for example, 2,4-toluene diisocyanate, 2,6-toluene diisocyanate, diphenylmethane 4,4′-diisocyanate, diphenylmethane 2,4′-diisocyanate, p-phenylene diisocyanate, biphenyl diisocyanates, 3,3′-dimethyl-4,4′-diphenylene diisocyanate, tetramethylene 1,4-diisocyanate, hexamethylene 1,6-diisocyanate, 2,2,4-trimethylhexane 1,6-diisocyanate, isophorone diisocyanate, ethylene diisocyanate, 1,12-dodecane diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate, hexahydrophenylene 1,3-diisocyanate, hexahydrophenylene 1,4-diisocyanate, perhydrodiphenylmethane 2,4′-diisocyanate, 4,4′-methylenedicyclohexyl diisocyanate (e.g., Desmodur® W from Bayer AG), tetramethylxylyl diisocyanates (e.g., TMXDI® from American Cyanamid) and mixtures of the aforementioned polyisocyanates.

Preferred for use as parent structures for the isocyanate group-containing component (B1) used in accordance with the invention are aliphatic and/or cycloaliphatic polyisocyanates. Examples of aliphatic polyisocyanates used preferably as parent structures are tetramethylene 1,4-diisocyanate, hexamethylene 1,6-diisocyanate, 2,2,4-trimethylhexane 1,6-diisocyanate, ethylene diisocyanate, 1,12-dodecane diisocyanate, isophorone diisocyanate, 4,4′-methylenedicyclohexyl diisocyanate (e.g., Desmodur® W from Bayer AG) and mixtures of the aforementioned polyisocyanates.

Further preferred as parent structures for the isocyanate group-containing component (B1) used in accordance with the invention are the polyisocyanates derived from such an aliphatic polyisocyanate by trimerization, dimerization, urethane formation, biuret formation, uretdione formation and/or allophanate formation, more particularly the biuret and/or the allophanate and/or the isocyanurate of such an aliphatic polyisocyanate. In a further embodiment of the invention, the isocyanate parent structures for component (B1) are polyisocyanate prepolymers having urethane structural units, which are obtained by reaction of polyols with a stoichiometric excess of aforementioned polyisocyanates. Polyisocyanate prepolymers of this kind are described in U.S. Pat. No. 4,598,131, for example.

Particularly preferred as parent structures for the isocyanate group-containing component (B1) used in accordance with the invention are hexamethylene diisocyanate, isophorone diisocyanate, and 4,4′-methylenedicyclohexyl diisocyanate, and/or the isocyanurates thereof and/or the biurets thereof and/or the uretdiones thereof and/or the allophanates thereof. Especially preferred as parent structures for the isocyanate group-containing component (B1) used in accordance with the invention are hexamethylene diisocyanate and/or its biuret and/or allophanate and/or isocyanurate and/or its uretdione, and also mixtures of said polyisocyanates.

Component (B1) in particular has at least one free or blocked isocyanate group and at least one silane group of the formula (II)

—X—Si—R″ₓG₃₋ₓ (II)

where
G is identical or different hydrolyzable groups,
X is organic radical, more particularly linear and/or branched alkylene or cycloalkylene radical having 1 to 20 carbon atoms, very preferably alkylene radical having 1 to 4 carbon atoms,
R″ is alkyl, cycloalkyl, aryl, or aralkyl, it being possible for the carbon chain to be interrupted by nonadjacent oxygen, sulfur, or NRa groups, where Ra is alkyl, cycloalkyl, aryl or aralkyl, and preferably R″ is alkyl radical, more particularly having 1 to 6 C atoms,
x is 0 to 2, preferably 0 to 1, more preferably 0.

The structure of these silane radicals as well affects the reactivity and hence also the very substantial conversion in the course of the curing of the coating. With regard to compatibility and to reactivity of the silanes, silanes having 3 hydrolyzable groups are used with preference, i.e., x is 0.

The hydrolyzable groups G may be selected from the group of the halogens, especially chlorine and bromine, from the group of the alkoxy groups, from the group of the alkylcarbonyl groups, and from the group of the acyloxy groups. Particularly preferred are alkoxy groups (OR′).

The structural units (II) are introduced preferably by reaction of—preferably aliphatic—polyisocyanates and/or the polyisocyanates derived therefrom by trimerization, dimerization, urethane formation, biuret formation, uretdione formation and/or allophanate formation with at least one amino-functional silane (IIa)

H—NR_{w}—(X—Si—R″ₓG₃₋ₓ)_{2-w} (IIa)

where X, R″, G, and x have the definition stated for formula (II) and R is hydrogen, alkyl, cycloalkyl, aryl, or aralkyl, it being possible for the carbon chain to be interrupted by nonadjacent oxygen, sulfur, or NRa groups, where Ra is alkyl, cycloalkyl, aryl, or aralkyl, and w is 0 or 1.

Suitability is possessed for example by the primary aminosilanes given later on as examples of the compounds (IIIa), or the secondary N-alkylaminosilanes given likewise as examples of the compounds (IIIa), or the aminobissilanes given as examples of the compounds (IVa).

Component (B1) preferably has at least one isocyanate group and also at least one structural unit (III) of the formula (III)

—NR—(X—SiR″x(OR′)3-x) (III),

and/or
at least one structural unit (IV) of the formula (IV)

—N(X—SiR″x(OR′)3-x)n(X′—SiR″y(OR′)3-y)m (IV)

where
R is hydrogen, alkyl, cycloalkyl, aryl, or aralkyl, it being possible for the carbon chain to be interrupted by nonadjacent oxygen, sulfur, or NRa groups, where Ra is alkyl, cycloalkyl, aryl, or aralkyl,
R′ is hydrogen, alkyl, or cycloalkyl, it being possible for the carbon chain to be interrupted by nonadjacent oxygen, sulfur or NRa groups, where Ra is alkyl, cycloalkyl, aryl, or aralkyl, and preferably R′ is ethyl and/or methyl,
X, X′ are linear and/or branched alkylene or cycloalkylene radical having 1 to 20 carbon atoms, preferably alkylene radical having 1 to 4 carbon atoms,
R″ is alkyl, cycloalkyl, aryl, or aralkyl, it being possible for the carbon chain to be interrupted by nonadjacent oxygen, sulfur, or NRa groups, where Ra is alkyl, cycloalkyl, aryl, or aralkyl, and preferably R″ is alkyl radical, more particularly having 1 to 6 C atoms,
n is 0 to 2, m is 0 to 2, m+n is 2, and x and y are 0 to 2.

Component (B1) more preferably has at least one isocyanate group and also at least one structural unit (III) of the formula (III) and at least one structural unit (IV) of the formula (IV).

The respective preferred alkoxy radicals (OR′) may be alike or different—what is critical for the structure of the radicals, however, is the extent to which they influence the reactivity of the hydrolyzable silane groups. Preferably R′ is an alkyl radical, more particularly having 1 to 6 C atoms. Particularly preferred are radicals R′ which raise the reactivity of the silane groups, i.e., which constitute good leaving groups. Thus a methoxy radical is preferred over an ethoxy radical, which is preferred in turn over a propoxy radical. With particular preference, therefore, R′ is ethyl and/or methyl, more particularly methyl.

The reactivity of organofunctional silanes may also be influenced considerably, furthermore, by the length of the spacers X, X′ between silane functionality and organic functional group serving for reaction with the constituent to be modified. As an example of this, mention may be made of the “alpha” silanes, which are available from Wacker and in which there is a methylene group, rather than the propylene group present in “gamma” silanes, between the Si atom and the functional group.

The components (B1) used with preference in accordance with the invention, functionalized with the structural units (III) and/or (IV), are obtained in particular by reaction of—preferably aliphatic—polyisocyanates and/or the polyisocyanates derived therefrom by trimerization, dimerization, urethane formation, biuret formation, uretdione formation and/or allophanate formation with at least one compound of the formula (IIIa)

H—NR—(X—SiR″ₓ(OR′)₃₋ₓ) (IIIa),

and/or with at least one compound of the formula (IVa)

HN(X—SiR″ₓ(OR′)₃₋ₓ)ₙ(X′—SiR″_{y}(OR′)_{3-y})ₘ (IVa),

where the substituents have the definition stated above.

The components (B1) used with particular preference in accordance with the invention, functionalized with the structural units (III) and (IV), are obtained more preferably by reaction of aliphatic polyisocyanates and/or the polyisocyanates derived therefrom by trimerization, dimerization, urethane formation, biuret formation, uretdione formation and/or allophanate formation with at least one compound of the formula (IIIa) and with at least one compound of the formula (IVa), the substituents having the definition stated above.

Compounds (IVa) preferred in accordance with the invention are bis(2-ethyltrimethoxysilyl)amine, bis(3-propyltrimethoxysilyl)amine, bis(4-butyltrimethoxysilyl)amine, bis(2-ethyltriethoxysilyl)amine, bis(3-propyltriethoxysilyl)amine and/or bis(4-butyltriethoxysilyl)amine. Especially preferred is bis(3-propyltrimethoxysilyl)amine. Such aminosilanes are available for example under the brand name DYNASYLAN® from DEGUSSA or Silquest® from OSI.

Compounds (IIIa) preferred in accordance with the invention are aminoalkyltrialkoxysilanes, such as preferably 2-aminoethyltrimethoxysilane, 2-aminoethyltriethoxysilane, 3-aminopropyl-trimethoxysilane, 3-aminopropyltriethoxysilane, 4-aminobutyltrimethoxysilane, and 4-aminobutyltriethoxysilane. Particularly preferred compounds (Ia) are N-(2-(trimethoxysilyl)ethyl)alkylamines, N-(3-(trimethoxysilyl)propyl)alkylamines, N-(4-(trimethoxysilyl)butyl)alkylamines, N-(2-(triethoxysilyl)ethyl)alkylamines, N-(3-(triethoxysilyl)propyl)alkylamines and/or N-(4-(triethoxysilyl)butyl)alkylamines. Especially preferred is N-(3-(trimethoxysilyl)propyl)butylamine. Such aminosilanes are available for example under the brand name DYNASYLAN® from DEGUSSA or Silquest® from OSI. Preferably, in component (B1), between 5 and 90 mol %, in particular between 10 and 80 mol %, more preferably between 20 and 70 mol %, and very preferably between 25 and 50 mol % of the isocyanate groups originally present have undergone reaction to form structural units (III) and/or (IV), preferably structural units (III) and (IV).

Moreover, in the silane and isocyanate group-containing component (B1), the total amount of bissilane structural units (IV) is between 10 and 100 mol %, preferably between 30 and 95 mol %, more preferably between 50 and 90 mol %, based in each case on the entirety of the structural units (IV) plus (III), and the total amount of monosilane structural units (III) is between 90 and 0 mol %, preferably between 70 and 5 mol %, more preferably between 50 and 10 mol %, based in each case on the entirety of the structural units (IV) plus (III).

### The Isocyanate- and Fluorine-Containing Component (B2)

It is essential to the invention that the coating materials comprise at least one isocyanate- and fluorine-containing component (B2) which is different from component (B1) and which has a parent structure derived from one or more polyisocyanates.

The polyisocyanates serving as parent structures for the isocyanate group-containing component (B2) used in accordance with the invention are the polyisocyanates already described for component (B1) and the polyisocyanates derived from such a polyisocyanate by trimerization, dimerization, urethane formation, biuret formation, uretdione formation and/or allophanate formation. In a further embodiment of the invention, the isocyanate parent structures for component (B2) are polyisocyanate prepolymers having urethane structural units, which are obtained by reaction of polyols with a stoichiometric excess of aforementioned polyisocyanates. Polyisocyanate prepolymers of this kind are described in U.S. Pat. No. 4,598,131, for example. Preferred for use as parent structures for the isocyanate group-containing component (B2) used in accordance with the invention are aliphatic and/or cycloaliphatic polyisocyanates.

Particularly preferred as parent structures for the isocyanate group-containing component (B2) used in accordance with the invention are hexamethylene diisocyanate, isophorone diisocyanate, and 4,4′-methylenedicyclohexyl diisocyanate, and/or the isocyanurates thereof and/or the biurets thereof and/or the uretdiones thereof and/or the allophanates thereof. Especially preferred as parent structures for the isocyanate group-containing component (B2) used in accordance with the invention are hexamethylene diisocyanate and/or its biuret and/or allophanate and/or isocyanurate and/or its uretdione, and also mixtures of said polyisocyanates.

The parent structure for the isocyanate group-containing component (B2) used in accordance with the invention may be derived from the same polyisocyanate or polyisocyanates as the parent structure for the isocyanate group-containing component (B1) used in accordance with the invention; however, the parent structures may also derive from different polyisocyanates. Preferably, the parent structure for the isocyanate group-containing component (B2) used in accordance with the invention does derive from the same polyisocyanate as the parent structure for the isocyanate group-containing component (B1) used in accordance with the invention.

Especially preferred as parent structures not only for the isocyanate group-containing component (B1) used in accordance with the invention but also for the isocyanate group-containing component (B2) used in accordance with the invention is hexamethylene diisocyanate and/or its biuret and/or allophanate and/or isocyanurate and/or its uretdione, and also mixtures thereof.

It is essential to the invention that component (B2) has at least one perfluoroalkyl group of the formula (I)

CR¹₃—(CR²₂)_{f}— (I),

where
R¹ and R² independently of one another are H, F and/or CF₃, but R¹ and R² may not both be H, and
f is 1 to 20, preferably 3 to 11, more preferably 5 to 7.

The structural units (I) are introduced preferably by reaction of—preferably aliphatic—polyisocyanates and/or the polyisocyanates derived therefrom by trimerization, dimerization, urethane formation, biuret formation, uretdione formation and/or allophanate formation with at least one (per)fluoroalkyl monoalcohol (FA) of the formula (Ta)

CR¹₃—(CR²₂)_{f}—(CH₂)ᵣ—O-A_{z}-H (Ia)

where
R¹ and R² independently of one another are H, F, or CF₃, but R¹ and R² may not both be H,
f is 1-20,
r is 1-6,
z is 0-100, preferably 0,
A is CR′R″—CR′″R″″—O or (CR′R″)ₐ—O or CO—(CR′R″)_{b}—O,
R′, R″, R′″, and R″″ independently of one another are H, alkyl, cycloalkyl, aryl, or any organic radical having 1 to 25 C atoms,
a and b are 3-5,
the polyalkylene oxide structural unit A_{z} comprising homopolymers, copolymers, or block polymers of any desired alkylene oxides, or comprising polyoxyalkylene glycols, or comprising polylactones.

Examples of compounds suitable as perfluoroalkyl alcohols (FA) are the (per)fluoroalkyl alcohols described in WO 2008/040428, page 33, line 4 to page 34, line 3, and also the (per)fluoroalkyl alcohols described in EP-B-1 664 222 B1, page 9, paragraph [0054], to page 10, paragraph [57], for example.

Component (B2) preferably has at least one perfluoroalkyl group of the formula (I-I) and/or of the formula (I-II)

CF₃(CF₂)ₙ— (I-I)

F(CF₂CF₂)ₗ— (I-II)

where
n is 1 to 20, preferably 3 to 11, more preferably 5 to 7,
l is 1 to 8, preferably 1 to 6, more preferably 2 to 3.

The structural units (I-I) are introduced preferably by reaction of—preferably aliphatic—polyisocyanates and/or the polyisocyanates derived therefrom by trimerization, dimerization, urethane formation, biuret formation, uretdione formation and/or allophanate formation with at least one (per) fluoroalkyl monoalcohol (FA) of the formula (I-Ia):

CF₃—(CF₂)ₙ—(CH₂)ₒ—O—H (I-Ia)

where n is 1 to 20, preferably 3 to 11, more preferably 5 to 7, and o is 1 to 10, preferably 1 to 4.

The structural units (I-II) are introduced preferably by reaction of—preferably aliphatic—polyisocyanates and/or the polyisocyanates derived therefrom by trimerization, dimerization, urethane formation, biuret formation, uretdione formation and/or allophanate formation with at least one (per) fluoroalkyl monoalcohol (FA) of the formula (I-IIa)

F(CF₂CF₂)ₗ—(CH₂CH₂O)ₘ—H (I-IIa)

where
l is 1 to 8, preferably 1 to 6, more preferably 2 to 3, and
m is 1 to 15, preferably 5 to 15.

Examples of suitable perfluoroalcohols are 3,3,4,4,5,5,6,6,7,7,8,8,8-tridecafluorooctan-1-ol, 3,3,4,4,5,5,6,6,7,7,8,8,9,9,10,10,10-heptadecafluoro-decan-1-ol, 3,3,4,4,5,5,6,6,7,7,8,8,9,9,10,10,11,11,12,12,12-heneicosafluorododecan-1-ol, 3,3,4,4,5,5,6,6,7,7,8,8,9,9,10,10,11,11,12,12,13,13, 14,14,14-pentacosafluorotetradecan-1-ol, 3,3,4,4,5,5,6,6,7,7,8,8,9,9,10,10, 11,11,12,12,13,13,14,14,15,15,16,16,16-nonacosafluorohexadecan-1-ol, 3,3,4,4,5,5,6,6,7,7,8,8-dodecafluoroheptan-1-ol, 3,3,4,4,5,5,6,6,7,7,8,8,9,9, 10,10-hexadecafluorononan-1-ol, 3,3,4,4,5,5,6,6,7,7,8,8,9,9,10,10,11,11,12,12-eicosafluoroundecan-1-ol, 3,3,4,4,5,5,6,6,7,7,8,8,9,9,10,10,11,11, 12,12,13,13,14,14-tetracosafluorotridecan-1-ol, and 3,3,4,4,5,5,6,6,7,7,8,8, 9,9,10,10,11,11,12,12,13,13,14,14,15,15,16,16-octacosafluoropentadecan-1-ol.

With particular preference component (B2) has at least one perfluoroalkyl group of the formula (I-I)

CF₃—(CF₂)ₙ— (I-I)

in which n is 1 to 20, more particularly 3 to 11, very preferably 5 to 7.

These preferred structural units (I-I) are introduced preferably by reaction of—preferably aliphatic—polyisocyanates and/or the polyisocyanates derived therefrom by trimerization, dimerization, urethane formation, biuret formation, uretdione formation and/or allophanate formation with at least one (per)fluoroalkyl monoalcohol (FA) of the formula (I-Ia)

CF₃—(CF₂)ₙ—(CH₂)ₒ—OH (I-Ia)

or mixtures of different fluoroalcohols of the formula (I-Ia), in which n is 1 to 8, preferably 1 to 6, more particularly 1 to 4, and o is 1 to 6, more particularly 1 to 4, and very preferably 1 to 2.

Very particular preference is given to using perfluoroalkylethanols of the formula (I-Ia) where o is 2, preferably 2-(perfluorohexyl)ethanol and 2-(perfluorooctyl)ethanol, and to mixtures of different perfluoroalkylethanols of the formula (I-IIIa), more particularly a mixture of 2-(perfluorohexyl)ethanol and 2-(perfluorooctyl)ethanol, optionally together with other (per)fluoroalkylethanols. Used with preference are perfluoroalkylethanol mixtures with 30 to 49.9 wt % of 2-(perfluorohexyl)ethanol and 30 to 49.9 wt % of 2-(perfluorooctyl)ethanol, such as the commercial products Fluowet® EA 612 and Fluowet® EA 812; 2-(perfluorohexyl)ethanol, such as the commercial product Daikin A-1620, or 2-(perfluorooctyl)ethanol, such as the commercial product Daikin A-1820, from Daikin Industries Ltd., Osaka, Japan. Very particular preference is given to using 2-(perfluorohexyl)ethanol.

Preferably, in component (B2), between 1 and 60 mol %, more preferably between 5 and 40 mol %, and very preferably between 10 and 30 mol % of the isocyanate groups originally present have undergone reaction to form structural units (I) and/or (I-I) and/or (I-II), preferably structural units (I-I).

The total fluorine content of the coating material composition of the invention is preferably between 0.05 and 10.0 mass % fluorine, more particularly between 0.1 and 8.0 mass % fluorine, more preferably between 0.2 and 4.0 mass % fluorine, based in each case on the binder fraction of the coating material composition.

### The Isocyanate Group-Containing Component (B3)

The coating material compositions may optionally further comprise an isocyanate group-containing component B3, which is different from B1 and B2. Suitability as isocyanate group-containing component (B3) is possessed by the polyisocyanates already described for components (B1) and (B2) and by the polyisocyanates derived from such a polyisocyanate by trimerization, dimerization, urethane formation, biuret formation, uretdione formation and/or allophanate formation. Preference is given to using, as component (B3), diisocyanates and polyisocyanates which differ from the polyisocyanate employed as parent structure for components (B1) and (B2). Employed in particular as (B3) are isophorone diisocyanate and 4,4′-methylenedicyclohexyl diisocyanate and/or the isocyanurates thereof and/or the biurets thereof and/or the uretdiones thereof and/or the allophanates thereof.

### The Catalyst (D) for the Crosslinking of the Silane Groups

Catalysts which can be used for the crosslinking of the alkoxysilyl units and also for the reaction between the hydroxyl groups of the compound (A) and the isocyanate groups of the compound (B) are compounds which are known per se. Examples are Lewis acids (electron-deficient compounds), such as tin naphthenate, tin benzoate, tin octoate, tin butyrate, dibutyltin dilaurate, dibutyltin diacetate, dibutyltin oxide, and lead octoate, for example, and also catalysts as described in WO-A-2006/042585. Also suitable, furthermore, are customary acid-based catalysts, such as, for example, dodecylbenzenesulfonic acid, toluenesulfonic acid, and the like. Catalysts used for the crosslinking of the alkoxysilyl units are preferably amine adducts of phosphoric acid or of sulfonic acid (e.g., Nacure products from King Industries).

Employed with particular preference as catalyst (D) are phosphorus-containing catalysts, more particularly phosphorus- and nitrogen-containing catalysts. In this context it is also possible to use mixtures of two or more different catalysts (D).

Examples of suitable phosphorus-containing catalysts (D) are substituted phosphonic diesters and diphosphonic diesters, preferably from the group consisting of acyclic phosphonic diesters, cyclic phosphonic diesters, acyclic diphosphonic diesters and cyclic diphosphonic diesters. Catalysts of this kind are described in, for example, German patent application DE-A-102005045228.

More particularly, however, substituted phosphoric monoesters and phosphoric diesters are used, preferably from the group consisting of acyclic phosphoric monoesters, cyclic phosphoric monoesters, acyclic phosphoric diesters, and cyclic phosphoric diesters, more preferably amine adducts of phosphoric monoesters and diesters.

Employed with very particular preference as catalyst (D) are the corresponding amine-blocked phosphoric esters, including, in particular, amine-blocked ethylhexyl phosphates and amine-blocked phenyl phosphates, very preferably amine-blocked bis(2-ethylhexyl) phosphate.

Examples of amines with which the phosphoric esters are blocked are, in particular, tertiary amines, examples being bicyclic amines, such as diazabicyclooctane (DABCO), diazabicyclononene (DBN), diazabicycloundecene (DBU), dimethyldodecylamine, or triethylamine, for example. Used with particular preference for blocking the phosphoric esters are tertiary amines, which ensure high activity of the catalyst under the curing conditions of 140° C. Used with very particular preference in particular at low curing temperatures of not more than 80° C. to block the phosphoric esters are bicyclic amines, especially diazabicyclooctane (DABCO).

Certain amine-blocked phosphoric acid catalysts are also available commercially (e.g., Nacure products from King Industries). An example which may be given is that known under the name Nacure 4167 from King Industries, as a particularly suitable catalyst, based on an amine-blocked partial ester of phosphoric acid.

The catalysts are used preferably in fractions of 0.01 to 20 wt %, more preferably in fractions of 0.1 to 10 wt %, based on the binder fraction of the coating material composition of the invention. A lesser activity on the part of the catalyst may be partly compensated by correspondingly higher quantities employed.

The coating material compositions of the invention may further comprise an additional amine catalyst based on a bicyclic amine, more particularly an unsaturated bicyclic amine. Examples of suitable amine catalysts are 1,5-diazabicyclo[4.3.0]non-5-ene or 1,8-diazabicyclo[5.4.0]undec-7-ene.

If these amine catalysts are employed, they are used preferably in fractions of 0.01 to 20 wt %, more preferably in fractions of 0.1 to 10 wt %, based on the binder fraction of the coating material composition of the invention.

### The Combination of Components (A), (B1), (B2), Optionally (C) and (D) and Also Further Components of the Coating Material Compositions

If the coating material compositions are one-component compositions, then isocyanate group-containing components (B1), (B2), and optionally (B3) are selected whose free isocyanate groups are blocked with blocking agents. The isocyanate groups may be blocked, for example, with substituted pyrazoles, more particularly with alkyl-substituted pyrazoles, such as 3-methylpyrazole, 3,5-dimethylpyrazole, 4-nitro-3,5-dimethylpyrazole, 4-bromo-3,5-dimethylpyrazole, and the like. With particular preference the isocyanate groups of components (B1), (B2), and optionally (B3) are blocked with 3,5-dimethylpyrazole.

The two-component (2K) coating material compositions that are particularly preferred in accordance with the invention are formed by the mixing, in a conventional way shortly before the coating material is applied, of a paint component comprising the polyhydroxyl group-containing component (A) and also further components, described below, with a further paint component comprising the polyisocyanate group-containing components (B1), (B2), and optionally (B3) and also, optionally, further of the components described below.

The polyhydroxyl component (A) may be present in a suitable solvent. Suitable solvents are those which permit sufficient solubility of the polyhydroxyl component. Examples of such solvents are those solvents (L) already listed for the polyisocyanate group-containing component (B).

The weight fractions of the polyol (A) and optionally (C) and also of the polyisocyanates (B1), (B2), and optionally (B3) are preferably selected such that the molar equivalents ratio of the hydroxyl groups of the polyhydroxyl group-containing component (A) plus optionally (C) to the isocyanate groups of components (B1) plus (B2) plus optionally (B3) is between 1:0.9 and 1:1.5, preferably between 1:0.9 and 1:1.1, more preferably between 1:0.95 and 1:1.05.

It is preferred in accordance with the invention for coating material compositions to be used that comprise from 20 to 60 wt %, preferably from 25 to 50 wt %, based in each case on the binder fraction of the coating material composition, of at least one polyhydroxyl group-containing component (A), more particularly of at least one polyhydroxyl group-containing polyacrylate (A) and/or of at least one polyhydroxyl group-containing polymethacrylate (A).

Likewise preferred is the use in accordance with the invention of coating material compositions which comprise from 30.5 to 80.0 wt %, preferably from 40.8 to 75.0 wt %, based in each case on the binder fraction of the coating material composition, of the polyisocyanate group-containing components (B1) plus (B2). Employed more particularly in accordance with the invention are coating material compositions which comprise from 30.0 to 79.5 wt %, preferably from 40.0 to 74.2 wt %, of the polyisocyanate group-containing component (B1) and from 0.5 to 30.0 wt %, preferably from 0.8 to 25.0 wt %, of the polyisocyanate group-containing component (B2), based in each case on the binder fraction of the coating material composition.

The coating material compositions may optionally further comprise an isocyanate group-containing component B3, different from B1 and B2. If this component (B3) is used, then it is employed typically in an amount of 0.1 to 10 wt %, based on the binder fraction of the coating material composition.

With further preference, in accordance with the invention, coating material compositions are used in which component (B1) and component (B2) are employed in amounts such that the ratio of the binder fraction of component (B1) in wt % to the binder fraction of component (B2) in wt % is between 0.5/1 to 25/1, preferably 1/1 to 20/1.

Besides these, the coating materials of the invention may further comprise one or more amino resins (E). Those contemplated are the customary and known amino resins, some of whose methylol and/or methoxymethyl groups may have been defunctionalized by means of carbamate groups or allophanate groups. Crosslinking agents of this kind are described in patent specifications U.S. Pat. No. 4,710,542 and EP-B-0 245 700, and also in the B. Singh and coworkers article “Carbamylmethylated Melamines, Novel Crosslinkers for the Coatings Industry” in Advanced Organic Coatings Science and Technology Series, 1991, volume 13, pages 193 to 207. Generally speaking, such amino resins (E) are used in proportions of 0 to 20 wt %, preferably of 0 to 15 wt %, based on the binder fraction of the coating material composition. If such amino resins (E) are used, they are employed more preferably in fractions of 3 to 15 wt %, based on the binder fraction of the coating material composition.

The coating material compositions of the invention preferably further comprise at least one customary and known coatings additive (F), different from components (A), (B1), (B2), (B3), (D), optionally (C), and optionally (E), in effective amounts, i.e., in amounts preferably up to 20 wt %, more preferably from 0 to 10 wt %, based in each case on the binder fraction of the coating material composition.

Examples of suitable coatings additives (F) are as follows:
especially UV absorbers;
especially light stabilizers such as HALS compounds, benzotriazoles, or oxalanilides;
radical scavengers;
slip additives;
polymerization inhibitors;
defoamers;
reactive diluents different from components (A) and (C), more particularly reactive diluents which become reactive only on reaction with further constituents and/or water, such as Incozol or aspartic esters, for example;
wetting agents different from components (A) and (C), such as siloxanes, fluorine compounds, carboxylic monoesters, phosphoric esters, polyacrylic acids and copolymers thereof, or polyurethanes;
adhesion promoters;
flow control agents;
rheological assistants, based for example on customary hydrophilic and/or hydrophobic fumed silica, such as various Aerosil® grades, or customary urea-based rheological assistants;
film-forming auxiliaries such as cellulose derivatives;
fillers such as, for example, nanoparticles based on silicon dioxide, aluminum oxide, or zirconium oxide; for further details, refer to Rompp Lexikon “Lacke und Druckfarben”, Georg Thieme Verlag, Stuttgart, 1998, pages 250 to 252;
flame retardants.

Particularly preferred are coating material compositions which comprise

25 to 50 wt %, based on the binder fraction of the coating material composition, of at least one polyhydroxyl group-containing polyacrylate (A) and/or of at least one polyhydroxyl group-containing polymethacrylate (A) and/or of at least one polyhydroxyl group-containing polyester polyol (A) and/or of a polyhydroxyl group-containing polyurethane (A),
40.0 to 74.2 wt %, based on the binder fraction of the coating material composition, of at least one component (B1),
0.8 to 25.0 wt %, based on the binder fraction of the coating material composition, of at least one component (B2),
0 to 10 wt %, based on the binder fraction of the coating material composition, of at least one component (B3),
0 to 5 wt %, based on the binder fraction of the coating material composition, of the hydroxyl group-containing component (C),
0 up to 15 wt %, based on the binder fraction of the coating material composition, of at least one amino resin (E),
0.1 to 10 wt %, based on the binder fraction of the coating material composition of the invention, of at least one catalyst (D) for the crosslinking, and
0 to 10 wt %, based on the binder fraction of the coating material composition, of at least one customary and known coatings additive (F).

The binder fraction of the coating material composition as indicated in the context of the amounts of the individual components is made up in each case of the sum of the binder fraction of component (A) plus the binder fraction of component (B1) plus the binder fraction of component (B2) plus the binder fraction of component (B3) plus the binder fraction of component (C) plus the binder fraction of component (E).

The coating materials of the invention are more particularly transparent coating materials, preferably clearcoats. The coating materials of the invention therefore comprise no pigments, or only organic transparent dyes or transparent pigments.

In a further embodiment of the invention, the binder mixture of the invention or the coating material composition of the invention may further comprise additional pigments and/or fillers and may serve for the production of pigmented topcoats or pigmented undercoats or surfacers, more particularly pigmented topcoats. The pigments and/or fillers employed for these purposes are known to the skilled person. The pigments are typically used in an amount such that the pigment-to-binder ratio is between 0.05:1 and 1.5:1, based in each case on the binder fraction of the coating material composition.

Since the coatings of the invention produced from the coating materials of the invention adhere outstandingly even to already-cured electrocoats, primer-surfacer coats, basecoats or customary and known clearcoats, they are outstandingly suitable, in addition to their use in automotive OEM (production-line) finishing, for automotive refinishing and/or for the coating of parts for installation in or on motor vehicles, and/or for the coating of commercial vehicles.

The application of the coating material compositions of the invention may take place by any of the customary application methods, such as, for example, spraying, knifecoating, spreading, pouring, dipping, impregnating, trickling or rolling. With respect to such application, the substrate to be coated may itself be at rest, with the application unit or equipment being moved. Alternatively, the substrate to be coated, more particularly a coil, may be moved, with the application unit being at rest relative to the substrate or being moved appropriately.

Preference is given to employing spray application methods, such as, for example, compressed air spraying, airless spraying, high speed rotation, electrostatic spray application (ESTA), alone or in conjunction with hot spray application such as hot air spraying, for example.

The curing of the applied coating materials of the invention may take place after a certain rest time. The rest time serves, for example, for the leveling and degassing of the coating films or for the evaporation of volatile constituents such as solvents. The rest time may be assisted and/or shortened through the application of elevated temperatures and/or through a reduced atmospheric humidity, provided that this does not entail any instances of damage to or change in the coating films, such as a premature complete crosslinking.

The thermal curing of the coating materials has no peculiarities in terms of method, but instead takes place in accordance with the customary and known methods, such as heating in a forced air oven or irradiation with IR lamps. This thermal curing may also take place in stages. Another preferred curing method is that of curing with near infrared (NIR radiation).

The thermal curing takes place advantageously at a temperature of 20 to 200° C., preferably 40 to 190° C. and more particularly 50 to 180° C., for a time of 1 min up to 10 h, preferably 2 min to 5 h and more particularly 3 min to 3 h, with longer cure times also being employable at low temperatures. For automotive refinishing and for the coating of plastics parts, and also for the coating of commercial vehicles, relatively low temperatures are typically employed here, of preferably between 20 and 80° C., more particularly between 20 and 60° C.

The coating materials of the invention are outstandingly suitable as decorative, protective and/or effect coatings and finishes on bodywork of means of transport (especially powered vehicles, such as cycles, motorcycles, buses, trucks or cars) or of parts thereof; on the interior and exterior of edifices; on furniture, windows and doors; on plastics moldings, especially CDs and windows; on small industrial parts, on coils, containers and packaging; on white goods; on films; on optical, electrical and mechanical components; and also on hollow glassware and articles of everyday use.

The coating material compositions of the invention can therefore be applied, for example, to an uncoated or precoated substrate, the coating materials of the invention being either pigmented or unpigmented. The coating material compositions and paint systems of the invention in particular, more particularly the clearcoats, are employed in the technologically and esthetically particularly demanding field of automotive OEM finishing and for the coating of plastics parts for installation in or on car bodies, more particularly for top-class car bodies, such as, for example, for producing roofs, hatches, hoods, fenders, bumpers, spoilers, sills, protective strips, side trim and the like, and for the finishing of commercial vehicles, such as, for example, of trucks, chain-driven construction vehicles, such as crane vehicles, wheel loaders and concrete mixers, buses, rail vehicles, watercraft, aircraft, and also agricultural equipment such as tractors and combines, and parts thereof, and also for automotive refinishing, with automotive refinishing encompassing not only the repair of the OEM finish on the line but also the repair of local defects, such as scratches, stone chip damage and the like, for example, and also complete recoating in corresponding repair workshops and car paint shops for the value enhancement of vehicles.

The plastics parts are typically composed of ASA, polycarbonates, blends of ASA and polycarbonates, polypropylene, polymethyl methacrylates or impact-modified polymethyl methacrylates, more particularly of blends of ASA and polycarbonates, preferably used with a polycarbonate fraction >40%, more particularly >50%.

ASA refers generally to impact-modified styrene/acrylonitrile polymers, in which graft copolymers of vinylaromatic compounds, more particularly styrene, and of vinyl cyanides, more particularly acrylonitrile, are present on polyalkyl acrylate rubbers in a copolymer matrix of, in particular, styrene and acrylonitrile.

With particular preference, the coating material compositions of the invention are used in multistage coating processes, more particularly in processes in which an optionally precoated substrate is coated first with a pigmented basecoat film and then with a film with the coating material composition of the invention.

The invention accordingly also provides multicoat color and/or effect finishes comprising at least one pigmented basecoat and at least one clearcoat applied thereon, these finishes being characterized in that the clearcoat has been produced from the coating material composition of the invention.

Not only water-thinnable basecoats but also basecoats based on organic solvents can be used. Suitable basecoats are described in, for example, EP-A-0 692 007 and in the documents listed therein at column 3 lines 50 et seq. Preferably, the applied basecoat is first dried—that is, in an evaporation phase, at least some of the organic solvent and/or of the water is removed from the basecoat film. Drying takes place preferably at temperatures from room temperature to 80° C. After drying has taken place, the coating material composition of the invention is applied. The two-coat finish is subsequently baked, preferably under conditions employed in automotive OEM finishing, at temperatures from 20 to 200° C. for a time of 1 min up to 10 h; in the case of the temperatures employed for automotive refinishing, which in general are between 20 and 80° C., more particularly between 20 and 60° C., longer cure times may also be employed.

In another preferred embodiment of the invention, the coating material composition of the invention is used as a transparent clearcoat for the coating of plastics substrates, particularly of plastics parts for interior or exterior installation. These plastics parts for interior or exterior installation are preferably coated likewise in a multistage coating process, in which an optionally precoated substrate or a substrate which has been pretreated for enhanced adhesion of the subsequent coatings (by means, for example, of flaming, corona treatment or plasma treatment of the substrate) is coated first with a pigmented basecoat film and thereafter with a film with the coating material composition of the invention.

### Examples

### Preparation of the Polyacrylate Polyol (A1)

A 5 liter Juvo reaction vessel with heating jacket, thermometer, stirrer, and top-mounted condenser was charged with 828.24 g of an aromatic solvent (solvent naphtha). With stirring and under an inert gas atmosphere (200 cm3/min nitrogen), the solvent was heated to 156° C. Using a metering pump, a mixture of 46.26 g of di-tert-butyl peroxide and 88.26 g of solvent naphtha was added uniformly dropwise over the course of 4.50 h. 0.25 h after the beginning of the addition, using a metering pump, 246.18 g of styrene, 605.94 g of n-butyl acrylate, 265.11 g of n-butyl methacrylate, 378.69 g of 4-hydroxybutyl acrylate, 378.69 g of hydroxyethyl acrylate, and 18.90 g of acrylic acid were added at a uniform rate over the course of 4 h. After the end of the addition, the temperature was maintained for a further 1.5 h and then the product was cooled to 80° C. The polymer solution was subsequently diluted with 143.73 g of solvent naphtha. The resulting resin had an acid number of 10.3 mg KOH/g (to DIN 53402), a solids content of 65%+/−1 (60 min, 130° C.), and a viscosity of 1153 mPa*s as per the test protocol of DIN ISO 2884-1 (60% in solvent naphtha).

### Preparation of the Polyacrylate Polyol (A2)

A 5 liter Juvo reaction vessel with heating jacket, thermometer, stirrer, and top-mounted condenser was charged with 705.30 g of an aromatic solvent (solvent naphtha). With stirring and under an inert gas atmosphere (200 cm3/min nitrogen), the solvent was heated to 140° C. Using a metering pump, a mixture of 156.90 g of tert-butyl peroxy-2-ethylhexanoate and 75.00 g of solvent naphtha was added uniformly dropwise over the course of 4.75 h. 0.25 h after the beginning of the addition, using a metering pump, 314.40 g of styrene, 314.40 g of hydroxypropyl methacrylate, 251.10 g of n-butyl methacrylate, 408.90 g of cyclohexyl methacrylate, and 282.90 g of hydroxyethyl methacrylate were added at a uniform rate over the course of 4 h. After the end of the addition, the temperature was maintained for a further 2.0 h and then the product was cooled to 120° C. The polymer solution was subsequently diluted with a mixture of 53.40 g of solvent naphtha, 160.50 g of methoxypropyl acetate, 71.40 g of butyl acetate, and 205.80 g of butyl glycol acetate. The resulting resin had an acid number of 1 mg KOH/g (to DIN 53402), a solids content of 55%+/−1 (60 min, 130° C.), and a viscosity of 5.3 dPa*s as per the test protocol of DIN ISO 2884-1.

### Preparation of the Polyacrylate Polyol (A3)

A 5 liter Juvo reaction vessel with heating jacket, thermometer, stirrer, and top-mounted condenser was charged with 782.10 g of an aromatic solvent (Shellsol A). With stirring and under an inert gas atmosphere (200 cm3/min nitrogen), the solvent was heated to 150° C. under superatmospheric pressure (max. 3.5 bar). Using a metering pump, a mixture of 42.57 g of di-tert-butyl peroxide and 119.19 g of solvent naphtha was added uniformly dropwise over the course of 4.75 h. 0.25 h after the beginning of the addition, using a metering pump, 1374.90 g of ethylhexyl acrylate, and 503.37 g of hydroxyethyl acrylate were added at a uniform rate over the course of 4 h. After the end of the addition, the polymer solution was maintained for 1.0 h at a temperature of 140° C., and then the product was cooled to 60° C. The polymer solution was subsequently diluted with 143.73 g of Shellsol A. The resulting resin had an acid number of 2.3 mg KOH/g (to DIN 53402), a solids content of 67%+/−1 (60 min, 130° C.), and a viscosity of 250 mPa*s as per the test protocol of DIN ISO 2884-1.

### Preparation of the Partly Silanized Isocyanate (B1)

A three-neck flask equipped with reflux condenser and a thermometer is charged with 67.6 parts by weight of trimerized hexamethylene diisocyanate (HDI) (commercial Desmodur® N3300 from Bayer Materials) and 25.8 parts by weight of solvent naphtha. With reflux cooling, nitrogen blanketing, and stirring, a mixture of 3.3 parts by weight of N-[3-(trimethoxysilyl)propyl]butylamine (Dynasylan® 1189 from Evonik) and 43.0 parts by weight of bis[3-(trimethoxysilyl)propyl]amine (Dynasylan® 1124 from Evonik) is metered in at a rate such that 50-60° C. is not exceeded. After the end of the metering, the reaction temperature is held at 50-60° C. until the isocyanate mass fraction as determined by titration is 60 mol %. The solution of the partly silanized polyisocyanate has a solids fraction of 69 wt % (60 min, 130° C.).

The resulting partly silanized isocyanate (B1) has a degree of silanization of 40 mol %, based on the isocyanate groups originally present, a fraction of 10 mol % of monosilane groups (I) and 90 mol % of bissilane groups (II), based in each case on the sum total of the monosilane groups (I) plus the bissilane groups (II), an NCO content of 6.2 wt % (based on 100% solids content), and a solids content of 80 wt %.

### Preparation of the Partly Fluorinated Isocyanate (B2)

For the preparation of the fluorine crosslinker, 67.6 parts by weight (0.1 mol) of the isocyanurate of hexamethylene diisocyanate (commercial Desmodur® N3300 from Bayer Materials) in 46.4 parts by weight of butyl acetate, together with 0.9 part by weight of 1,4-diazabicyclo[2.2.2]octane [DABCO crystal] (1.33 wt % based on solids content of the isocyanate (B2)) and 2.8 parts by weight of triethyl orthoformate (3 wt % based on solids content of the isocyanate (B2)), are charged to a round-bottom flask. Then 25.5 parts by weight (0.07 mol) of 2-(perfluorohexyl)ethanol are added slowly at room temperature by means of a dropping funnel, with stirring and nitrogen blanketing. Care is taken to ensure that the temperature during the additions of the 2-(perfluorohexyl)ethanol does not exceed 50-60° C. This temperature is maintained until (about 3 to 4 h) the theoretical NCO content of 12.5% is reached. As soon as this figure is reached, the batch is cooled and the following final characteristic data are ascertained:

The resulting partly fluorinated isocyanate (B2) has a solids content of 65.5%+/−1 (60 min, 130° C.), an NCO content of 12.5%+/−0.8 (calculated on 100% solids content), and a degree of fluorination of 20 mol %, based on the NCO groups originally present.

Preparation Example for the Phosphoric Ester-Based Catalyst (D), Reacted with DABCO

As described in WO 2009/077180 on pages 32 and 33 in the section on DABCO-based catalyst, the catalyst is prepared from 11.78 g (0.105 mol) of 1,4-diazabicyclo[2.2.2]octane [DABCO crystal], 32.24 g (0.100 mol) of bis(2-ethylhexyl) phosphate, 10.00 g (0.100 mol) of methyl isobutyl ketone, and 20.00 g (0.226 mol) of ethyl acetate.

### Preparation of the Coating Materials (KI) to (K3) of Inventive Examples 1 to 3 and of the Coating Material of Comparative Example V1

Shortly before application, the polyhydroxyl group-containing components (A1), (A2), and (A3) (polyacrylate), the catalyst (D), the light stabilizers, the flow control agent, and the solvent are combined with the above-described partly silanized isocyanate (B1) and with the above-described partly fluorinated isocyanate (B2), or, in comparative example V1, only with the above-described partly silanized isocyanate (B1), and these ingredients are stirred together until a homogeneous mixture is produced.

TABLE 1
Composition of the inventive coating materials (K1)
to (K3) and of the coating material V1 of the comparative
example in parts by weight and wt %

| | Inventive | Inventive | Inventive | Comparative |
|---|---|---|---|---|
| | example 1 | example 2 | example 3 | example V1 |
| Polyacrylate | 42.8 | 42.8 | 42.8 | 42.8 |
| polyol (A1) | | | | |
| Polyacrylate | 14.2 | 14.2 | 14.2 | 14.2 |
| polyol (A2) | | | | |
| Polyacrylate | 9.6 | 9.6 | 9.6 | 9.6 |
| polyol (A3) | | | | |
| Butyl acetate | 28.6 | 28.6 | 28.6 | 28.6 |
| Flow control | 0.2 | 0.2 | 0.2 | 0.2 |
| agent ¹⁾ | | | | |
| Tinuvin ® | 1.1 | 1.1 | 1.1 | 1.1 |
| 384 ²⁾ | | | | |
| Tinuvin ® | 1.0 | 1.0 | 1.0 | 1.0 |
| 292 ³⁾ | | | | |
| Catalyst (D) | 1.5 | 1.5 | 1.5 | 1.5 |
| Silanized | 65.0 | 73.0 | 81.0 | 93.5 |
| isocyanate | | | | |
| (B1) | | | | |
| Fluorinated | 18.0 | 12.0 | 6.0 | — |
| isocyanate | | | | |
| (B2) | | | | |

Key to table 1
¹⁾ commercial, polymeric, silicone-free flow control agent
²⁾ Tinuvin ® 384 = commercial light stabilizer based on a benzotriazole, from BASF S.E.
³⁾ Tinuvin ® 292 = commercial light stabilizer based on a sterically hindered amine from BASF S.E.

### Production of the Coatings of Inventive Examples 1 to 3 and of Comparative Example V1

Metal Bonder panels are coated in succession with a commercial cathodic electrocoat (e-coat: CathoGuard® 500 from BASF Coatings GmbH, film thickness 20 μm) and with a commercial waterborne primer-surfacer (SecuBloc® from BASF Coatings GmbH), with baking in each case. This system is subsequently coated with commercial black aqueous basecoat material (ColorBrite® from BASF Coatings GmbH) and flashed off at 80° C. for 10 minutes. The coating materials of inventive examples B1 to B3 and of comparative example V1 are subsequently applied using a gravity-feed cup gun, and are baked together with the basecoat material at 140° C. for 20 minutes. The clearcoat film thickness is 30 to 35 μm, the basecoat film thickness ˜15 μm.

The gloss is then determined using the micro-haze plus gloss meter from Byk. The scratch resistance of the surfaces of the resulting coatings was determined by means of the Crockmeter test (based on EN ISO 105-X12 with 10 double rubs and an applied force of 9N, using 9 μm abrasive paper (3M 281Q Wetordry™Production™), with subsequent determination of the residual gloss at 200 using a commercial gloss instrument). The surface energy was determined using a contact angle meter (DSA 100 from KRUSS) according to DIN 55660-2. For this purpose, in a static measurement, contact angles were determined with the test liquids water, diiodomethane, and ethylene glycol, and then the surface energy was calculated using the model of Owens and Wendt. The results of testing are listed in table 2.

TABLE 2
Test results for the coatings

| | Inventive | Inventive | Inventive | Comparative |
|---|---|---|---|---|
| | example 1 | example 2 | example 3 | example V1 |
| Gloss/haze | 83/15 | 84/16 | 83/16 | 85/14 |
| Crockmeter | 82% | 86% | 91% | 81% |
| Surface energy | 16.6 | 18.7 | 25.0 | 36.0 |
| [mN/m] | | | | |

### Discussion of the Test Results

Comparison of inventive examples 1 to 3 shows that by optimizing the formulation it is possible to minimize the surface energy for a comparable scratch resistance. Comparison of inventive examples 1 to 3 with comparative example V1 shows that a conventional system has far from the same low surface energy as the systems described in the inventive examples.

In addition, the chemical resistance with respect to various test substances was investigated for the coating of inventive example B1 and the coating of comparative example V1. For the determination of chemical resistance, the metal test panels provided with the cured coatings (gradient oven panels from Byk-Gardener) are subjected to the test substance, applied in drops (approximately 0.25 ml) using a pipette from a distance of 2 cm. The panels are subjected to a temperature gradient in the longitudinal direction of the panel, from 35 to 80° C., for 30 minutes in a temperature gradient oven (from Byk-Gardener). Following exposure to the substances, the substances were removed under running water and the damage was assessed visually after 24 hours. For the assessment of the resistance, the range (temperature) of first visible attack for clearcoat is reported.

The resistance toward 36% strength sulfuric acid was determined, moreover, by dropwise application of the sulfuric acid for 2 minutes and storage in an oven at 65° C. for 1 hour: The figure reported is the time in minutes after which initial swelling is observed.

The resistance with respect to ethanol, rim cleaner, cavity preservative, premium grade gasoline, and diesel fuel was determined in the same way.

The results are reported in table 3.

TABLE 3
Chemical resistance of the coatings of inventive
example 1 and of the comparative example

| | Inventive | Comparative |
|---|---|---|
| | example 1 | example V1 |
| Sulfuric acid 1%, temperature ° C. | 51 | 48 |
| (first marking) | | |
| Hydrochloric acid 10%, temperature | 57 | 52 |
| ° C. (first marking) | | |
| Sodium hydroxide 10%, temperature ° C. | 43 | 46 |
| (first marking) | | |
| Pancreatin, temperature ° C. (first | 40 | <37 |
| marking) | | |
| Tree resin, temperature ° C. (first | <37 | 44 |
| marking) | | |
| Water, temperature ° C. (first | 63 | >73 |
| marking) | | |
| Sulfuric acid 36% (2-minute | 12 | 10 |
| dripping, 1 h 65° C.) initial swelling | | |
| after min. | | |
| Sulfuric acid 36% (2-minute | 36 | 48 |
| dripping, 1 h 65° C.) initial etching | | |
| after min. | | |
| Ethanol BMW # 116447/water 5° d | 2 | 0 |
| DIN 38409-6 60:40 (vol %) 1 h 60° C., | | |
| surface alteration after 24 h | | |
| Rim cleaner, forced air oven 1 h | 1 | 2 |
| 60° C., surface alteration after 24 h | | |
| Cavity preservative, forced air oven | 1 | 2 |
| 1 h 60° C., surface alteration after | | |
| 24 h | | |
| Super-grade unleaded fuel | 0 | 0 |
| DIN EN 228, 10 min continual | | |
| dripping, surface alteration after | | |
| 24 h | | |
| Diesel fuel | 0 | 0 |
| Chemistry total | 1 | 1 |

In addition, the scratch resistance was tested with the aid of a laboratory carwash unit in accordance with DIN EN ISO 20566 DE (AMTEC wash brush resistance). The results are reported in table 4.

TABLE 4
Scratch resistance of the coatings of inventive
example 1 and of the comparative example

| | Inventive | Comparative |
|---|---|---|
| Scratch resistance | example 1 | example 1 |
| Amtec: initial gloss 20° | 83 | 88 |
| Amtec: gloss 20° without | 34 | 36 |
| cleaning | | |
| Amtec: gloss 20° with cleaning | 75 | 82 |
| Amtec: % d gloss without | 41 | 41 |
| cleaning | | |
| Amtec: % d gloss with cleaning | 90 | 93 |
| Reflow 60 min 60° C.: gloss 20° | 35 | 37 |
| uncleaned | | |
| Reflow 60 min 60° C.: gloss 20° | 78 | 82 |
| cleaned | | |
| Reflow 60 min 60° C.: % d gloss | 42 | 42 |
| uncleaned | | |
| Reflow 60 min 60° C.: % d gloss | 94 | 93 |
| cleaned | | |

Lastly, moreover, the weathering resistance in the constant humidity test according to DIN EN ISO 6270-2 DE and the stone-chip resistance in accordance with DIN EN ISO 20567-1 DE and BMW, AA 0081 “mono-impact” were determined.

The results are reported in table 5.

Comparison of inventive example 1 with comparative example V1 shows that the systems are comparable apart from the desired, lower surface energy.

TABLE 5
Weathering stability and stone-chip resistance of the coatings
of inventive example 1 and of the comparative example

| | Inventive | Comparative |
|---|---|---|
| Constant humidity 240 h | example 1 | example 1 |
| Blistering straight after exposure, | 0 | 0 |
| amount | | |
| Blistering straight after exposure, | 0 | 0 |
| size | | |
| Blistering 1 h after exposure, | 0 | 0 |
| amount | | |
| Blistering 1 h after exposure, size | 0 | 0 |
| Gloss 20° C. before exposure | 83 | 88 |
| Gloss 20° C. after exposure | 83 | 88 |
| GT 2 mm before exposure | 1 | 1 |
| GT 1 h after exposure | 1 | 1 |
| GT 24 h after exposure | 1 | 1 |
| Stone chipping 2 bar, rating | 2 | 2.5 |
| Mono-impact −30° C., parting plane | to the e- | to the e- |
| | coat | coat |
| Stone-chip with VDAKWT10 corrosion | 2 | 2.5 |
| testing, rating | | |
| Rust undermining minimum mm | 1.5 | 1.4 |
| Rust undermining maximum mm | 2.5 | 2.2 |
| Rust undermining average mm | 2 | 1.7 |
| Rust undermining standard deviation | 0.27 | 0.26 |
| mm | | |
| Rust undermining variation | 13.5 | 15.29 |
| coefficient % | | |
| Rust undermining under-rusting mm | 0.9 | 0.7 |
| Rust undermining scribe width mm | 0.3 | 0.3 |
| Degree of edge rust (BASF scale) | 1 | 1 |
| Degree of surface rust DIN 53210 | 0 | 0 |

1: A nonaqueous coating material composition, comprising:
(A) at least one polyhydroxyl group-containing component (A);
(B1) at least one isocyanate and silane group-containing component (B1);
(D) at least one catalyst (D) for the crosslinking of silane groups,
which composition comprises:
(B2) at least one isocyanate group-containing component (B2) which is different from component (B1) and which additionally has at least one perfluoroalkyl group of the formula (I):
CR¹₃—(CR²₂)^{f}— (I),
wherein:
R¹ and R² independently of one another are H, F and/or CF₃, but R¹ and R² may not both be H; and
f is 1 to 20.

2: The coating material composition as claimed in claim 1, wherein component (B2) has at least one perfluoroalkyl group of the formula (I-I) and/or of formula (I-II):
CF₃(CF₂)ₙ— (I-I),
F(CF₂CF₂)ₗ— (I-II)
wherein:
n is 1 to 20; and
l is 1 to 8.

3: The coating material composition as claimed in claim 1, wherein component (B2) is preparable by reaction of polyisocyanates and/or the polyisocyanates derived therefrom by trimerization, dimerization, urethane formation, biuret formation, uretdione formation and/or allophanate formation with:
(1) at least one (per)fluoroalkyl monoalcohol (FA) of the formula (I-Ia):
CF₃—(CF₂)ₙ—(CH₂)ₒ—O—H (I-Ia),
and/or
(2) at least one (per)fluoroalkyl monoalcohol (FA) of the formula (I-IIa),
F(CF₂CF₂)₁—(CH₂CH₂O)ₘ—H (I-IIa),
wherein:
n is 1 to 20;
o is 1 to 10;
l is 1 to 8; and
m is 1 to 15.

4: The coating material composition as claimed in claim 1, wherein, in component (B2), between 1 and 60 mol of the isocyanate groups originally present have undergone reaction to form structural units (I), (I-I), (I-II), or a combination thereof.

5: The coating material composition as claimed in claim 1, wherein component (B1) has at least one free or blocked isocyanate group and at least one silane group of the formula (II):
—X—Si—R″ₓG₃₋ₓ (II),
wherein:
G is identical or different hydrolyzable groups;
X is an organic radical;
R″ is alkyl, cycloalkyl, aryl, or aralkyl, it being possible for the carbon chain to be interrupted by nonadjacent oxygen, sulfur, or NRa groups, where Ra is alkyl, cycloalkyl, aryl or aralkyl; and
x is 0 to 2.

6: The coating material composition as claimed in claim 1, wherein component (B1) has at least one isocyanate group and also at least one structural unit (III) of the formula (III):
—NR—(X—SiR″x(OR′)3-x) (III), and/or
at least one structural unit (IV) of the formula (IV):
—N(X—SiR″x(OR′)3-x)n(X′—SiR″y(OR′)3-y)m (IV),
wherein:
R is hydrogen, alkyl, cycloalkyl, aryl, or aralkyl, it being possible for the carbon chain to be interrupted by nonadjacent oxygen, sulfur, or NRa groups, where Ra is alkyl, cycloalkyl, aryl, or aralkyl;
R′ is hydrogen, alkyl, or cycloalkyl, it being possible for the carbon chain to be interrupted by nonadjacent oxygen, sulfur or NRa groups, where Ra is alkyl, cycloalkyl, aryl, or aralkyl;
X, X′ are linear and/or branched alkylene or cycloalkylene radical having 1 to 20 carbon atoms;
R″ is alkyl, cycloalkyl, aryl, or aralkyl, it being possible for the carbon chain to be interrupted by nonadjacent oxygen, sulfur, or NRa groups, where Ra is alkyl, cycloalkyl, aryl, or aralkyl;
n is 0 to 2;
m is 0 to 2;
m+n is 2; and
x and y are 0 to 2.

7: The coating material composition as claimed in claim 1, wherein component (B1) is preparable by reaction of polyisocyanates and/or polyisocyanates derived therefrom by trimerization, dimerization, urethane formation, biuret formation, uretdione formation and/or allophanate formation with
at least one compound of the formula (IIIa):
H—NR—(X—SiR″ₓ(OR′)₃₋ₓ) (IIIa), and/or
with at least one compound of the formula (IVa);
HN(X—SiR″ₓ(OR′)₃₋ₓ)ₙ(X′—SiR″_{y}(OR′)_{3-y})ₘ (IVa),
wherein:
R is hydrogen, alkyl, cycloalkyl, aryl, or aralkyl, it being possible for the carbon chain to be interrupted by nonadjacent oxygen, sulfur, or NRa groups, where Ra is alkyl, cycloalkyl, aryl, or aralkyl;
R′ is hydrogen, alkyl, or cycloalkyl, it being possible for the carbon chain to be interrupted by nonadjacent oxygen, sulfur or NRa groups, where Ra is alkyl, cycloalkyl, aryl, or aralkyl;
R″ is alkyl, cycloalkyl, aryl, or aralkyl, it being possible for the carbon chain to be interrupted by nonadjacent oxygen, sulfur, or NRa groups, where Ra is alkyl, cycloalkyl, aryl, or aralkyl
X, X′ are linear and/or branched alkylene or cycloalkylene radical having 1 to 20 carbon atoms;
n is 0 to 2;
m is 0 to 2;
m+n is 2; and
x and y are 0 to 2.

8: The coating material composition as claimed in claim 1, wherein, in component (B1), between 10 and 80 mol of the isocyanate groups originally present have undergone reaction to form structural units (III) and/or (IV), preferably.

9: The coating material composition as claimed in claim 1, wherein, in the silane and isocyanate group-containing component (B1), the total amount of bissilane structural units (IV) is between 10 and 100 mol based in each case on the entirety of the structural units (IV) plus (III), and the total amount of monosilane structural units (III) is between 90 and 0 mol based in each case on the entirety of the structural units (IV) plus (III).

10: The coating material composition as claimed in claim 1, wherein the polyisocyanate or polyisocyanates serving as parent structures for component (B1) and/or component (B2) is or are selected from the group of aliphatic, cycloaliphatic polyisocyanates, mixtures thereof, and polyisocyanates derived from such polyisocyanates by trimerization, dimerization, urethane formation, biuret formation, uretdione formation and/or allophanate formation.

11: The coating material composition as claimed in claim 1, wherein at least one of the following conditions is satisfied:
the coating material composition comprises from 30.5 to 80.0 wt based in each case on the binder fraction of the coating material composition, of the polyisocyanate group-containing components (B1) plus (B2); and
the ratio of the binder fraction of component (B1) in wt % to the binder fraction of component (B2) in wt % is between 0.5/1 to 25/1.

12: The coating material composition as claimed in claim 1, wherein the catalyst (D) or the catalysts (D) of the coating material composition is or are selected from the group of substituted phosphonic diesters, substituted diphosphonic diesters, substituted phosphoric monoesters, substituted phosphoric diesters, corresponding amine-blocked phosphoric esters, and mixtures thereof.

13: The coating material composition as claimed in claim 1, wherein at least one of the following conditions is satisfied:
the polyols (A) have an OH number of 30 to 400 mg KOH/g; and
the polyols (A) are selected from the group of polyester polyols, polyurethane polyols, polysiloxane polyols, polyacrylate polyols, polymethacrylate polyols, and mixtures of these polyols.

14: A method for producing a multicoat paint system, the method comprising applying a pigmented basecoat film to an optionally precoated substrate and thereafter applying a film of the coating material composition as claimed in claim 1.

15: A clearcoat material, comprising the coating material composition as claimed in claim 1.

16: A multicoat effect and/or color paint system, comprising at least one pigmented basecoat and at least one clearcoat disposed thereon, wherein the clearcoat has been produced from a coating material composition as claimed in claim 1.

17: The method of claim 14, wherein the multicoat paint system is adapted to function as a multicoat paint system suitable for automotive OEM finishing, for the finishing of parts for installation in or on automobiles and/or utility vehicles, and for automotive refinish.
